(19) United States
(12) Patent Application Publication
(10) Pub. No.: US 2026/0001982 A1
(43) Pub. Date: Jan. 1, 2026

(54) POLYURETHANE FOAM, BATTERY OR ELECTRIC DEVICE, AND METHOD FOR PRODUCING POLYURETHANE FOAM

(71) Applicants: INOAC CORPORATION, Aichi (JP); ROGERS INOAC CORPORATION, Aichi (JP)

(72) Inventors: Seiji OYAIZU, Aichi (JP); Takahito NOGUCHI, Aichi (JP)

(73) Assignees: INOAC CORPORATION, Aichi (JP); ROGERS INOAC CORPORATION, Aichi (JP)

(21) Appl. No.: 19/111,394

(22) PCT Filed: Sep. 28, 2023
(86) PCT No.: PCT/JP2023/035445

§ 371 Date: Mar. 13, 2025

(30) Foreign Application Priority Data
Sep. 30, 2022 (JP) 2022-158884

(51) Int. Cl. C08G 18/08; C08G 18/48; C08G 101/00; C08J 9/12; C08K 3/04; C08K 3/32

(52) U.S. Cl. CPC C08G 18/14; C08G 18/4816; C08J 9/122; C08K 3/04; C08K 3/32; C08G 2101/00; C08G 2110/0066; C08J 2203/06; C08J 2375/08; C08K 2003/323

(57) ABSTRACT

[Summary] To provide a polyurethane foam excellent in flame retardancy, while having high density.

[Solution] In the present technology, first, a polyurethane foam containing an inorganic phosphoric acid compound and expanded graphite and having a density of 150 kg/m³ or more is provided. The thickness of the polyurethane foam according to the present technology can be 10 mm or less. The polyurethane foam according to the present technology can be used in batteries or electric devices. The polyurethane foam according to the present technology can be produced by a polyurethane foam production method including a step of mixing a polyol, an isocyanate, an inorganic phosphoric acid compound, expanded graphite, and a gas.

### TECHNICAL FIELD

The present technology relates to a polyurethane foam. More specifically, the present technology relates to a polyurethane foam having flame retardancy, a battery or an electric device using the polyurethane foam, and a method for producing the polyurethane foam.

### BACKGROUND ART

Polyurethane foams are widely used in a variety of fields, including furniture such as sofas and chairs, bedding such as mattresses and pillows, clothing such as underwear, daily necessities such as dishwashing sponges and cleaning sponges, interior products for vehicles and aircraft such as car seats, electronic devices such as mobile phones, cameras, and televisions, electrical appliances such as home appliances, and toys, and miscellaneous goods. Various developments are being carried out to improve the quality and impart new functions according to each field and purpose.

For example, Patent Literature 1 discloses a flame-retardant polyurethane foam having excellent strength such as tensile strength and tear strength and low compression set while improving flame retardancy by using, as polyols, (A) 50 to 80 parts by mass of a first polyol made of a polymer polyol having a number average molecular weight of 1500 to 4500 and a functionality of 3, based on 100 parts by mass of the total polyols: (B) 5 to 16 parts by mass of a second polyol made of a polyether polyol having a number average molecular weight of 300 to 900 and a functionality of 3, based on 100 parts by mass of the total polyols; and (C) 1 to 6 parts by mass of a third polyol made of a polyester polyol having a functionality of 2 or 3, based on 100 parts by mass of the total polyols.

For example, Patent Literature 2 discloses a polyurethane foam having excellent heat resistance, moist heat resistance, and flame retardancy by using either or both of expanded graphite and phosphorus-based powder flame retardants. Patent Literature 3 discloses a polyurethane foam having remarkably excellent flame retardancy that satisfies the V-0 standard of the UL-94 vertical flame test with a small amount of flame retardant by using a non-halogen flame retardant as the flame retardant. Patent Literature 4 discloses a polyurethane foam having a UL94 vertical flame rating of V-0 by using a non-reactive phosphorus compound that is present in an amount ranging from 1 to 20 mass percent based on the total mass of the polyurethane foam and has a cumulative weight loss of 2% or less at 200° C. as measured by thermogravimetric analysis.

### CITATION LIST

### Patent Literature

Patent Literature 1: JP-A No. 2012-082273

Patent Literature 2: JP-A No. 2016-176049

Patent Literature 3: JP-A No. 2011-252111

Patent Literature 4: Japanese Translation of International Patent Application Publication (JP-T) No. 2016-510837

### SUMMARY OF INVENTION

### Technical Problem

In recent years, there has been an increasing demand for polyurethane foams that can be used as cushioning materials for vibration and shock absorption in electric devices such as mobile phones, cameras, and televisions, and electrical appliances such as home appliances, sealing materials for various batteries, and sealing materials for the periphery of batteries and electronic control units in electric vehicles. To be used for these purposes, they are required to be flame retardant and high density. As mentioned above, technologies for imparting flame retardancy to polyurethane foams are being developed, but the flame retardancy of high-density polyurethane foams is still in the development stage.

Therefore, the main object of the present technology is to provide a polyurethane foam that has high density and excellent flame retardancy.

### Solution to Problem

In the present technology, first, a polyurethane foam containing an inorganic phosphoric acid compound and expanded graphite and having a density of 150 kg/m³ or more is provided.

The polyurethane foam according to the present technology can have a thickness of 10 mm or less.

The polyurethane foam according to the present technology can be used in batteries or electric devices.

The polyurethane foam according to the present technology can be produced by a polyurethane foam production method including a step of mixing a polyol, an isocyanate, an inorganic phosphoric acid compound, expanded graphite, and a gas.

### DESCRIPTION OF EMBODIMENTS

A preferred embodiment for carrying out the present technology will be described below. The embodiments described below are representative examples of the present technology, and any of the embodiments can be combined. In addition, the scope of the present technology is not narrowly interpreted by these.

### 1. Composition for Producing Polyurethane Foam

The polyurethane foam according to the present technology is produced using a composition containing an inorganic phosphoric acid compound and expanded graphite. The composition used for producing the polyurethane foam according to the present technology may also contain a polyol, an isocyanate, a catalyst, a foam stabilizer, a foaming agent, etc., as necessary.

The polyurethane foam according to the present technology is preferably produced by a mechanical froth method as described below. That is, the composition used for producing the polyurethane foam according to the present technology can be suitably used as a composition for mechanical froth. Each component will be described in detail below.

### (1) Inorganic Phosphoric Acid Compounds

The polyurethane foam according to the present technology is characterized by the use of an inorganic phosphoric acid compound. By using an inorganic phosphoric acid compound and expanded graphite described later, even polyurethane foams with a density of 150 kg/m³ or more can exhibit high flame retardancy.

The inorganic phosphoric acid compound that can be used in the present technology can be one or more types of inorganic phosphoric acid compounds that can be used in the production of polyurethane foams, and can be freely selected and used as long as the purpose and effect of the present technology are not impaired. Examples of the inorganic phosphoric acid compound that can be used in the present technology include inorganic polyphosphates such as ammonium polyphosphate, and inorganic phosphates such as ammonium phosphate.

The amount of the inorganic phosphoric acid compound in the composition used for producing the polyurethane foam according to the present technology can be freely set as long as it does not impair the purpose and effect of the present technology. In the present technology, the lower limit of the content of the inorganic phosphoric acid compound in the composition is, for example, 10 parts by mass or more, preferably 15 parts by mass or more, more preferably 20 parts by mass or more, relative to 100 parts by mass of a polyol described later. By setting the lower limit of the content of the inorganic phosphoric acid compound in the composition within this range, the flame retardancy of the polyurethane foam produced can be further improved.

In the present technology, the upper limit of the content of the inorganic phosphoric acid compound in the composition is, for example, 80 parts by mass or less, preferably 70 parts by mass or less, and more preferably 60 parts by mass or less, relative to 100 parts by mass of a polyol described below. Setting the upper limit of the content of the inorganic phosphoric acid compound in the composition within this range contributes to cost reduction and can improve the mechanical properties of the polyurethane foam produced.

### (2) Expanded Graphite

The polyurethane foam according to the present technology is characterized by the use of expanded graphite. By using the above-described inorganic phosphoric acid compound and expanded graphite, even polyurethane foams with a density of 150 kg/m³ or more can exhibit high flame retardancy.

The amount of expanded graphite in the composition used to produce the polyurethane foam according to the present technology can be freely set as long as it does not impair the purpose and effect of the present technology. In the present technology, the lower limit of the content of expanded graphite in the composition is, for example, 10 parts by mass or more, preferably 15 parts by mass or more, and more preferably 20 parts by mass or more, relative to 100 parts by mass of a polyol described below. By setting the lower limit of the content of expanded graphite in the composition within this range, the flame retardancy of the polyurethane foam produced can be further improved.

In the present technology, the upper limit of the content of expanded graphite in the composition is, for example, 80 parts by mass or less, preferably 70 parts by mass or less, and more preferably 60 parts by mass or less, relative to 100 parts by mass of a polyol described below. Setting the upper limit of the content of expanded graphite in the composition within this range contributes to cost reduction and can improve the mechanical properties of the polyurethane foam produced.

The total amount of the above-described inorganic phosphoric acid compound and expanded graphite in the composition used to produce the polyurethane foam according to the present technology can also be freely set as long as it does not impair the purpose and effect of the present technology. In the present technology, the lower limit of the total amount of the inorganic phosphoric acid compound and expanded graphite in the composition is, for example, 20 parts by mass or more, preferably 30 parts by mass or more, more preferably 40 parts by mass or more, even more preferably 43 parts by mass or more, and even more preferably 50 parts by mass or more, relative to 100 parts by mass of a polyol described below. By setting the lower limit of the total amount of the inorganic phosphoric acid compound and expanded graphite in the composition within this range, the flame retardancy of the polyurethane foam produced can be further improved.

In the present technology, the upper limit of the total amount of the inorganic phosphoric acid compound and expanded graphite in the composition is, for example, 160 parts by mass or less, preferably 120 parts by mass or less, and more preferably 100 parts by mass or less, relative to 100 parts by mass of a polyol described below. By setting the upper limit of the total amount of the inorganic phosphoric acid compound and expanded graphite in the composition within this range, it is possible to contribute to cost reduction and prevent the viscosity of the mixture of raw materials from becoming too high during production, thereby improving workability. In addition, it is possible to improve the mechanical properties of the polyurethane foam produced.

### (3) Polyol

As the polyol that can be used in the present technology, one or more types of polyols that can be used in the production of polyurethane foams can be freely selected and used, so long as the purpose and effect of the present technology are not impaired. Examples of the polyol that can be used in the present technology include polyester polyols, polycarbonate polyols, polyether polyols, and polyester ether polyols.

Examples of the polyester polyols include polyester polyols such as polypropylene glycol obtained by a dehydration condensation reaction of aliphatic dicarboxylic acids such as succinic acid, adipic acid, sebacic acid, and azelaic acid; aliphatic carboxylic acids such as ricinoleic acid; aromatic dicarboxylic acids such as phthalic acid, terephthalic acid, isophthalic acid, and naphthalenedicarboxylic acid; alicyclic dicarboxylic acids such as hexahydrophthalic acid, hexahydroterephthalic acid, and hexahydroisophthalic acid; or acid esters or acid anhydrides thereof with ethylene glycol, 1,3-propylene glycol, 1,2-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, or a mixture thereof; and include polylactone polyols and polycaprolactone polyols obtained by ring-opening polymerization of lactone monomers such as ∈-caprolactone and methylvalerolactone. In addition to these, examples of the polyester polyol include polyols having a naturally derived ester group.

Examples of the polycarbonate polyols include those obtained by reacting at least one of polyhydric alcohols such as ethylene glycol, 1,2-propylene glycol, 1,3-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, and diethylene glycol with diethylene carbonate, dimethyl carbonate, diethyl carbonate, and the like.

Examples of the polyether polyols include polyethylene glycol, polypropylene glycol, polytetramethylene ether glycol, etc., which are obtained by polymerizing cyclic ethers such as ethylene oxide, propylene oxide, tetrahydrofuran, etc., and copolyethers thereof. The polyether polyols can also be obtained by polymerizing the above-mentioned cyclic ethers using polyhydric alcohols such as glycerin and trimethylolethane.

Examples of the polyester ether polyols include those obtained by a dehydration condensation reaction of an aliphatic, aromatic, or alicyclic dicarboxylic acid exemplified above for the polyester polyols, or an acid ester or acid anhydride thereof, with a glycol such as diethylene glycol or a propylene oxide adduct, or a mixture thereof.

In this technology, a biodegradable polyol can also be used in consideration of the environment. As the biodegradable polyol that can be used in this technology, one or more types of biodegradable polyols that can be used in the production of polyurethane foam can be freely selected and used as long as the purpose and effect of this technology are not impaired. Examples thereof include polyglycolic acid (PGA), polylactic acid (PLA), polybutylene succinate (PBS), polybutylene succinate adipate (PBSA), polybutylene adipate terephthalate (PBAT), polycaprolactone (PCL), polyethylene glycol (PEG), polyvinyl alcohol (PVA), polyhydroxyalkanoic acid (PHA), cellulose, cellulose acetate, chitosan, starch, modified starch, xylitol, sorbitol, mannitol, maltitol, castor oil-based polyol, and other naturally derived esters having a hydroxyl group, and the like.

### (4) Isocyanate

The isocyanate that can be used in the present technology can be freely selected from one or more types of isocyanates that can be used in the production of polyurethane foam, as long as the purpose and effect of the present technology are not impaired. For example, one or more of aromatic isocyanates, aliphatic isocyanates, and alicyclic isocyanates can be freely combined and used.

Examples of the aromatic isocyanates that can be used in the present technology include 2,4-tolylene diisocyanate, 2,6-tolylene diisocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, xylylene diisocyanate, 3,3′-dimethyl-4,4′-biphenylene diisocyanate, and 3,3′-dimethoxy-4,4′-biphenylene diisocyanate.

Examples of the aliphatic isocyanates that can be used in the present technology include trimethylene diisocyanate, 1,2-propylene diisocyanate, butylene diisocyanate (tetramethylene diisocyanate, 1,2-butylene diisocyanate, 2,3-butylene diisocyanate, 1,3-butylene diisocyanate), hexamethylene diisocyanate (HDI), pentamethylene diisocyanate, 2,2,4-trimethylhexamethylene diisocyanate, 2,4-trimethylhexamethylene diisocyanate, 2,6-diisocyanate methylcaprate, lysine diisocyanate, lysine ester triisocyanate, 1,6,11-undecane triisocyanate, 1,3,6-hexamethylene triisocyanate, trimethylhexamethylene diisocyanate, 1,5-pentamethylene diisocyanate (PDI), decamethylene diisocyanate, and derivatives thereof.

Examples of the alicyclic isocyanates include 1,3-cyclopentane diisocyanate, 1,3-cyclopentene diisocyanate, cyclohexane diisocyanate (1,4-cyclohexane diisocyanate, 1,3-cyclohexane diisocyanate), 3-isocyanatomethyl-3,5,5-trimethylcyclohexyl isocyanate (isophorone diisocyanate, IPDI), dimer acid diisocyanate, transcyclohexane 1,4-diisocyanate, hydrogenated tolylene diisocyanate (hydrogenated TDI), hydrogenated tetramethylxylylene diisocyanate (hydrated TMXDI), and other monocyclic alicyclic isocyanates: norbornene diisocyanate, norbornane diisocyanate methyl, bicycloheptane triisocyanate, diisocyanatomethyl bicycloheptane, di(diisocyanatomethyl)tricyclodecane, and other cross-linked cyclic alicyclic isocyanates, and derivatives thereof.

The amount of the isocyanate used in the present technology can be freely set as long as it does not impair the purpose and effect of the present technology. In the present technology, the lower limit of the isocyanate in the composition is, for example, 20 parts by mass or more, preferably 40 parts by mass or more, more preferably 60 parts by mass or more, relative to 100 parts by mass of the polyol. Even if the amount of the isocyanate is small, there is no problem as long as the amounts of the isocyanate and the polyol are appropriate, but if the isocyanate index is less than 80, the produced polyurethane foam may have insufficient mechanical strength (tensile/elongation) or insufficient hardness. Therefore, in the present technology, the isocyanate index is preferably 80 or more, more preferably 85 or more, and even more preferably 90 or more. By setting the lower limit of the isocyanate index within this range, the mechanical strength (tensile/elongation) and hardness of the produced polyurethane foam can be improved.

In the present technology, the upper limit of the isocyanate content in the composition is, for example, 300 parts by mass or less, preferably 200 parts by mass or less, more preferably 150 parts by mass or less, relative to 100 parts by mass of the polyol. By setting the upper limit of the isocyanate content in the composition within this range, there is an advantage in reducing costs. As described above, even if the amount of the isocyanate is large, there is no problem as long as the amounts of the isocyanate and the polyol are appropriate, but if the isocyanate index exceeds 150, the mechanical strength (tensile/elongation) and hardness of the produced polyurethane foam may become too large, and flexibility may be impaired. Therefore, in the present technology, the isocyanate index is preferably 150 or less, more preferably 140 or less, and even more preferably 130 or less. By setting the lower limit of the isocyanate index within this range, the mechanical strength (tensile/elongation) and hardness of the produced polyurethane foam can be prevented from becoming too large, and a soft polyurethane foam with improved flexibility can be obtained.

### (5) Foam Stabilizer

A foam stabilizer can be used in the production of polyurethane foam according to the present technology. As the foam stabilizer that can be used in the present technology, one or more types of foam stabilizers that can be used in the production of polyurethane foam can be freely selected and used as long as they do not impair the purpose and effect of the present technology.

Examples of the foam stabilizer include silicone-based foam stabilizers, fluorine-containing compound-based foam stabilizers, surfactants, etc. Examples of the silicone-based foam stabilizer include those mainly composed of siloxane chains, those in which the siloxane chain and polyether chain have a linear structure, those that diverge and are branched, and those in which the polyether chain is modified to be pendant to the siloxane chain.

The amount of the foam stabilizer in the composition used to produce the polyurethane foam according to the present technology can be freely set as long as it does not impair the purpose and effect of the present technology. In the present technology, the lower limit of the content of the foam stabilizer in the composition is, for example, 0.1 parts by mass or more, preferably 0.3 parts by mass or more, more preferably 0.5 parts by mass or more, relative to 100 parts by mass of the polyol. By setting the lower limit of the content of the foam stabilizer in the composition within this range, the foaming reaction can be stabilized, and as a result, a polyurethane foam with excellent mechanical properties and appearance can be obtained.

In the present technology, the upper limit of the content of the foam stabilizer in the composition is, for example, 10 parts by mass or less, preferably 7 parts by mass or less, and more preferably 5 parts by mass or less, relative to 100 parts by mass of the polyol. Setting the upper limit of the content of the foam stabilizer in the composition within this range can contribute to cost reduction.

### (6) Catalyst

A catalyst can be used in the production of polyurethane foam according to the present technology. As the catalyst that can be used in the present technology, one or more types of catalysts that can be used in the production of polyurethane foam can be freely selected and used as long as the purpose and effect of the present technology are not impaired.

Examples of the catalyst include metal catalysts (organometallic catalysts) such as organic iron compounds, organic nickel compounds, organic tin compounds, organic bismuth compounds, organic lead compounds, organic cobalt compounds, organic zirconium compounds, and organic zinc compounds: and amine catalysts such as triethylamine, triethylenediamine (TEDA), tetramethylguanidine, diethanolamine, bis(2-dimethylaminoethyl)ether, N,N,N′,N″,N″-pentamethyldiethylenetriamine, imidazole compounds, dimethylpiperazine, N-methyl-N′-(2-dimethylamino)ethylpiperazine, N-methyl-N′-(2-hydroxyethyl)piperazine and other piperazine-based amines, N-methylmorpholine, N-ethylmorpholine and other morpholine-based amines, and amines called DBU homologues, such as 1,8-diazabicyclo-[5,4,0] -undecene-7 (DBU), 1,5-diazabicyclo-[4,3,0] -nonene-5 (DBN), 1,8-diazabicyclo-[5,3,0] -decene-7 (DBD), and 1,4-diazabicyclo-[3,3,0] octene-4 (DBO).

The amount of the catalyst in the composition used to produce the polyurethane foam according to the present technology can be freely set as long as it does not impair the purpose and effect of the present technology. In the present technology, the lower limit of the catalyst content in the composition is, for example, 0.01 parts by mass or more, preferably 0.05 parts by mass or more, more preferably 0.1 parts by mass or more, relative to 100 parts by mass of the polyol. By setting the lower limit of the catalyst content in the composition within this range, various reactions during production can be promoted, and as a result, a polyurethane foam with excellent mechanical properties and appearance can be obtained.

In the present technology, the upper limit of the catalyst content in the composition is, for example, 10 parts by mass or less, preferably 5 parts by mass or less, more preferably 2 parts by mass or less, relative to 100 parts by mass of the polyol. By setting the upper limit of the catalyst content in the composition within this range, it is possible to prevent instability of various reactions during production. As a result, a polyurethane foam having excellent mechanical properties and appearance can be obtained.

### (7) Foam-Forming Gas

A foam-forming gas can be used in the production of polyurethane foam according to the present technology. As the foam-forming gas that can be used in the present technology, one or more types of foam-forming gases that can be used in the production of polyurethane foam can be freely selected and used as long as the purpose and effect of the present technology are not impaired.

Examples of the foam-forming gas include inert gases such as dry air and nitrogen. The mixing ratio of the foam-forming gas with other raw materials can be freely set according to the application of the polyurethane foam to be produced, as long as it does not impair the purpose and effect of the present technology. In the present technology, the mixing ratio of the foam-forming gas with other raw materials can be set to, for example, 10 volume % or more, preferably 15 volume % or more, and more preferably 20 volume % or more, based on 100 volume % of the foam-forming gas and other raw materials combined.

In this technology, the upper limit of the mixing ratio of the foam-forming gas with other raw materials can be set to, for example, 100 volume % or less, preferably 95 volume % or less, and more preferably 90 volume % or less, based on 100 volume % of the foam-forming gas and other raw materials combined.

### (8) Foaming Agent

The polyurethane foam according to the present technology can be produced by a mechanical froth method as described later, in which case it is possible to produce the polyurethane foam according to the present technology without a foaming agent, but the present technology also allows the use of a foaming agent. As the foaming agent that can be used in the present technology, one or more types of foaming agents that can be used in the production of polyurethane foam can be freely selected and used as long as they do not impair the purpose and effect of the present technology.

The foaming agent that can be used in the present technology may be either a chemical foaming agent or a physical foaming agent. Examples of the chemical foaming agents include reactive type foaming agents that generate carbon dioxide gas to cause foaming by reacting with water, and the above-mentioned isocyanates of carboxylic acids such as formic acid and acetic acid, and organic or inorganic thermal decomposition type chemical foaming agents. Examples of the organic foaming agents include azo compounds such as azodicarbonamide (ADCA), azodicarboxylate metal salts (barium azodicarboxylate, etc.), azobisisobutyronitrile (AIBN), nitroso compounds such as N,N′-dinitrosopentamethylenetetramine (DPT), hydrazine derivatives such as hydrazodicarbonamide, 4,4′-oxy bis(benzenesulfonylhydrazide), and toluenesulfonylhydrazide (TSH), and semicarbazide compounds such as toluenesulfonylsemicarbazide. Examples of the inorganic foaming agents include ammonium carbonate, sodium carbonate, ammonium hydrogen carbonate, sodium hydrogen carbonate, ammonium nitrite, sodium borohydride, and anhydrous monosodium citrate.

Examples of the physical foaming agents include fluorocarbons such as hydrochlorofluorocarbons (HCFCs) and hydrofluorocarbons (HFCs), hydrofluoroolefins (HFOs), halogen-containing hydrocarbons such as dichloromethane, volatile hydrocarbons such as heptane, hexane, pentane, and cyclopentane, and carbon dioxide, nitrogen, and air.

The amount of the foaming agent in the composition used to produce the polyurethane foam according to the present technology can be freely set as long as it does not impair the purpose and effect of the present technology. In the present technology, the content of the foaming agent in the composition is, for example, 10 parts by mass or less, preferably 7 parts by mass or less, and more preferably 5 parts by mass or less, relative to 100 parts by mass of the polyol. By setting the upper limit of the content of the foaming agent in the composition within this range, it is possible to suppress formation defects due to excessive foaming, and also to contribute to cost reduction.

### (9) Antioxidant

The present technology is characterized by the use of an antioxidant. As the antioxidant that can be used in the present technology, one or more types of antioxidants that can be used in the production of polyurethane foams can be freely selected and used as long as the effect of the present technology is not impaired. For example, one or more types of antioxidants selected from naphthylamine-based, diphenylamine-based, p-phenyldiamine-based, quinoline-based, hydroquinone derivatives, monophenol-based, thiobisphenol-based, hindered phenol-based, phosphite-based, etc. can be freely combined and used.

The amount of the antioxidant in the composition used to produce the polyurethane foam according to the present technology can be freely set as long as it does not impair the purpose and effect of the present technology. In the present technology, the lower limit of the content of the antioxidant in the composition is, for example, 0.01 parts by mass or more, preferably 0.03 parts by mass or more, and more preferably 0.05 parts by mass or more, relative to 100 parts by mass of the polyol. By setting the lower limit of the content of the antioxidant in the composition within this range, the effect of preventing discoloration due to scorch prevention can be improved.

In the present technology, the upper limit of the content of the antioxidant in the composition is, for example, 5 parts by mass or less, preferably 4 parts by mass or less, and more preferably 3 parts by mass or less, relative to 100 parts by mass of the polyol. Setting the upper limit of the content of the antioxidant in the composition within this range can contribute to cost reduction.

### (10) Moisture Absorbent

A moisture adsorbent can be used in the production of polyurethane foam according to the present technology. As the moisture adsorbent that can be used in the present technology, one or more types of moisture adsorbents that can be used in polyurethane foam can be freely selected and used as long as the purpose and effect of the present technology are not impaired. In particular, when water is not used as a foaming agent, it is preferable to use a moisture adsorbent, and physical properties, density, etc. can be controlled.

Examples of the moisture adsorbent include zeolite, silica gel, calcium oxide, activated carbon, potassium hydroxide, sodium hydroxide, and lithium hydroxide.

The amount of the moisture adsorbent in the composition used in the production of polyurethane foam according to the present technology can be freely set as long as it does not impair the purpose and effect of the present technology. In the present technology, the lower limit of the content of the moisture adsorbent in the composition is, for example, 0.1 parts by mass or more, preferably 0.3 parts by mass or more, and more preferably 0.5 parts by mass or more, relative to 100 parts by mass of the polyol.

In the present technology, the upper limit of the content of the moisture adsorbent in the composition is, for example, 10 parts by mass or less, preferably 7 parts by mass or less, and more preferably 5 parts by mass or less, relative to 100 parts by mass of the polyol.

### (11) Other

In the production of the polyurethane foam according to the present technology, one or more types of various components that can be used in the production of polyurethane foam can be freely selected and used as other components depending on the purpose, as long as the purpose and effects of the present technology are not impaired.

Examples of components that can be used in the production of polyurethane foams according to the present technology include flame retardants other than inorganic phosphoric acid compounds and expanded graphite, and pigments, stabilizers, plasticizers, colorants, crosslinking agents, antibacterial agents, dispersants, and ultraviolet absorbers.

### 2. Polyurethane Foam

The polyurethane foam according to the present technology contains an inorganic phosphoric acid compound and expanded graphite. It may also contain a foam-forming gas. That is, the polyurethane foam according to the present technology is produced using the above-mentioned composition. The amounts of the inorganic phosphoric acid compound, the expanded graphite, and the foam-forming gas in the polyurethane foam according to the present technology are the same as those in the above-mentioned composition, so that the description thereof is omitted here.

### (1) Density

The polyurethane foam according to the present technology is characterized in that it has a density of 150 kg/m³ or more. Since the polyurethane foam according to the present technology has a density of 150 kg/m³ or more, it can be suitably used as a cushioning material for absorbing vibration and shock in electronic devices such as mobile phones, cameras, and televisions, and electric devices such as home appliances, a sealing material for various batteries, and a sealing material for the periphery of the battery and electronic control units of electric vehicles.

The effect of the present technology can be exhibited as long as the density of the polyurethane foam according to the present technology is 150 kg/m³ or more, but the density is more preferably 180 kg/m³ or more, and further preferably 200 kg/m³ or more.

The upper limit of the density of the polyurethane foam according to the present technology can be freely set as long as it does not impair the purpose and effect of the present technology, but is, for example, 1200 kg/m³ or less, preferably 1000 kg/m³ or less, and more preferably 800 kg/m³ or less. By setting the density of the polyurethane foam within this range, it is possible to impart cushioning properties without impairing the flexibility of the polyurethane foam (preventing it from becoming hard).

### (2) Thickness

The thickness of the polyurethane foam according to the present technology can be freely set as long as it does not impair the purpose and effect of the present technology, and the polyurethane foam according to the present technology has excellent flame retardancy even when its thickness is 10 mm or less.

The lower limit of the thickness of the polyurethane foam according to the present technology can be freely set as long as it does not impair the purpose and effect of the present technology, but is, for example, 0.5 mm or more, preferably 0.8 mm or more, and more preferably 1 mm or more. By setting the thickness of the polyurethane foam within this range, it is possible to achieve better flame retardancy.

The upper limit of the thickness of the polyurethane foam according to the present technology can be freely set as long as it does not impair the purpose and effects of the present technology, but is, for example, 10 mm or less, preferably 9.5 mm or less, and more preferably 9.0 mm or less.

### (3) Use

The polyurethane foam according to the present technology can be used for various purposes in various fields by utilizing its high quality. For example, it can be suitably used for furniture such as sofas and chairs, bedding such as mattresses and pillows, clothing such as underwear, daily necessities such as dishwashing sponges and cleaning sponges, products for vehicle and aircraft interiors such as car seats, architectural joint materials, architectural cushioning materials, architectural seal materials, household appliance seal materials, electric device cushioning materials, electronic equipment cushioning materials, electric device seal materials, electronic equipment seal materials, various battery seal materials, soundproofing materials, packaging materials, vehicle insulation materials, vehicle battery seal materials, vehicle electronic control unit seal materials, dew prevention materials, interior materials, household appliance insulation materials, pipe insulation materials, various covers, cushioning materials, toys, miscellaneous goods, etc.

The polyurethane foam according to the present technology has excellent flame retardancy and can therefore be suitably used around heat sources in various applications.

### 3. Battery or Electric Device

The battery or electric device according to the present technology is a battery or electric device using the polyurethane foam according to the present technology described above. Examples of the battery or electric device include personal computers (electronic calculators), PDAs (personal digital assistants), mobile phones, telephones, video movie players, digital still cameras, televisions, electronic books, electronic dictionaries, music players, radios, headphones, game consoles, navigation systems, pacemakers, hearing aids, power tools, electric shavers, refrigerators, air conditioners, stereos, water heaters, microwave ovens, dishwashers, washing machines, dryers, lighting equipment, toys, medical equipment, robots, road conditioners, traffic lights, etc.

### 4. Method for Producing Polyurethane Foam

The polyurethane foam according to the present technology can be produced by preparing a composition by mixing each component of the composition described above, and proceeding with a resinification reaction and a foaming reaction. The resinification reaction and the foaming reaction can be carried out by freely combining general methods as long as they do not impair the purpose and effect of the present technology.

In the method for producing polyurethane foam according to the present technology, it is particularly preferable to adopt a mechanical froth method. By adopting the mechanical froth method, it is possible to produce a polyurethane foam with a higher density than by a chemical foaming method. In addition, it is also possible to produce a polyurethane foam with a smaller thickness.

As a specific method of the mechanical froth method, a general mechanical froth method can be adopted as long as it does not impair the purpose and effect of the present technology. For example, the mixing raw materials of the above-mentioned composition other than the foam-forming gas are charged into a mixing head, and the mixing raw materials are stirred and mixed to become homogeneous while mixing the foam-forming gas therein, and then the mixture is heated and cured on a release paper or the like or in a mold to produce a polyurethane foam.

### EXAMPLES

The present technology will be described in more detail below based on examples. Note that the examples described below are representative examples of the present technology, and the scope of the present technology is not to be interpreted narrowly by these examples.

### (1) Raw Materials

Polyol 1: Polyoxyalkylene polyol (polyether polyol obtained by polymerizing ethylene oxide and propylene oxide, functional group number: 3, molecular weight: 3300, hydroxyl value: 50 mgKOH/g)

Polyol 2: Polyoxypropylene polyether polyol (functional group number: 2, molecular weight: 2000, hydroxyl value 56 mgKOH/g)

Polyol 3: Polyoxypropylene polyether polyol (functional group number: 3, molecular weight: 600, hydroxyl value 280 mgKHO/g)

Polyol 4: Castor oil-based polyol (functional group number: 2.5, molecular weight: 645, hydroxyl value: 217 mg KOH/g)

Foam stabilizer: siloxane-based foam stabilizer (Dow Toray Co., Ltd. “SZ-1952”)

Catalyst 1: Nickel-based metal catalyst (Kusumoto Chemicals, Ltd. “K-KAT”)

Catalyst 2: Iron-based metal catalyst (Nihon Kagaku Sangyo Co., Ltd. “FIN-P1”)

Pigment: Carbon black

Antioxidant: Hindered phenol-based antioxidant (Songwon Industrial Co., Ltd. “Songnox 1135”)

Moisture adsorbent: Zeolite

Flame retardant: ammonium polyphosphate, expanded graphite, or aluminum hydroxide

Isocyanate: aromatic isocyanate (NCO % 33.5) (BASF INOAC Polyurethanes Ltd. “Lupranate M5S”)

Foam-forming gas: Nitrogen

### (2) Production of Polyurethane Foam

The above components were prepared in the blending ratios shown in Table 4 below to obtain mixing raw materials for each Example and Comparative Example. The mixing raw materials were then charged into a mixing head, and stirred and mixed homogeneously while mixing a foam-forming gas (inert gas: nitrogen) in the blending ratio (volume %) shown in Table 4 below. The mixed mixing raw materials were then supplied onto a continuously supplied film of a predetermined thickness to a thickness shown in Table 1 below, and heat-cured at 120 to 200° C. to produce sheet-like polyurethane foams.

### (3) Evaluation

### [Compression Set]

The compression set was measured in accordance with JIS K6401. A value of 10% or less was judged to have passed the test.

[Flame retardancy]

The flame retardancy was evaluated in accordance with the UL94 standard.

### <Horizontal Flame Test For Foamed Materials: HBF, HF-1>

A test piece (length 50±1 mm×width 150±5 mm×thickness 13 mm) cut out from the polyurethane foam of each Example and Comparative Example was placed horizontally on a wire mesh held horizontally, and one end of the test piece was exposed to a flame for 60 seconds.

In the HBF method, a sample was judged to have passed the test if the burning rate between the 25 mm mark and the 125 mm mark satisfied the criteria shown in Table 1 below.

TABLE 1
[Judgment criteria]

| Thickness of test specimen | Burning rate |
|---|---|
| 3 mm or more | 40 mm/min or less |
| Less than 3 mm | 75 mm/min or less |

*Passed, even if self-extinguished before marked line

In the HF method, a test piece was judged to have passed the test if it satisfied the criteria shown in Table 2 below with regard to the combustion behavior and the presence or absence of ignition of the cotton placed 175±25 mm below the wire mesh.

TABLE 2

| Judgment criteria | HF-1 |
|---|---|
| Burning time for each test | 2 seconds or less up to 4 pieces |
| speciment in a set of five | 10 seconds or less up to 1 piece |
| Burning + glowing time for | 30 seconds or less |
| each test specimen | |
| Damaged length of each sample | Less than 60 mm |
| Cotton ignition caused by dripping | None |

*UL94HBF evaluation criteria: burning rate 40 mm/min or less between 100 mm marked lines, or burning is completed by 125 mm marked line.

### <Vertical Flame Test for Foamed Material: V-0, V-1>

A test specimen (length 50±1 mm×width 150±5 mm×thickness 13 mm) cut out from the polyurethane foam of each Example and Comparative Example was attached vertically to a clamp and exposed to a 20 mm flame for 10 seconds twice, and the test specimen was judged to have passed the test if it satisfied the criteria shown in Table 3 below with respect to its combustion behavior and the presence or absence of ignition of cotton placed 30010 mm below the bottom end of the test specimen.

TABLE 3

| Judgment criteria | V-0 | V-1 |
|---|---|---|
| Burning time for each | 10 seconds or less | 30 seconds or less |
| test specimen | | |
| Total burning time for | 50 seconds or less | 250 seconds or less |
| 5 pieces | | |
| Burning + glowing time | 30 seconds or less | 60 seconds or less |
| for each test specimen | | |
| Burning to clamp | None | None |
| Cotton ignition caused | None | None |
| by dripping | | |

### [Viscosity]

The viscosity at 23° C. of the mixture of raw materials other than the isocyanate was measured using a Brookfield touch panel viscometer “DV2T”.

### (4) Result

The results are shown in Table 4 below.

| | | Example | | | | | | | | |
|---|---|---|---|---|---|---|---|---|---|---|
| | | 1 | 2 | 3 | 4 | 5 | 6 | 7 | 8 | 9 |
| Blending | Polyol 1 | 36.5 | 36.5 | 36.5 | 36.5 | 36.5 | 36.5 | 36.5 | 36.5 | 36.5 |
| ratio | Polyol 2 | 7.9 | 7.9 | 7.9 | 7.9 | 7.9 | 7.9 | 7.9 | 7.9 | 7.9 |
| (Parts by | Polyol 3 | 9.0 | 9.0 | 9.0 | 9.0 | 9.0 | 9.0 | 9.0 | 9.0 | 9.0 |
| mass | Polyol 4 | 46.6 | 46.6 | 46.6 | 46.6 | 46.6 | 46.6 | 46.6 | 46.6 | 46.6 |
| relative | Foam stabilizer | 3.8 | 3.8 | 3.8 | 3.8 | 3.8 | 3.8 | 3.8 | 3.8 | 3.8 |
| to 100 | Catalyst 1 | 0.40 | 0.40 | 0.40 | 0.40 | 0.40 | 0.40 | 0.40 | 0.40 | 0.40 |
| parts by | Catalyst 2 | 0.02 | 0.02 | 0.02 | 0.02 | 0.02 | 0.02 | 0.02 | 0.02 | 0.02 |
| mass of | Pigment | 1.0 | 1.0 | 1.0 | 1.0 | 1.0 | 1.0 | 1.0 | 1.0 | 1.0 |
| the sum | Antioxidant | 0.1 | 0.1 | 0.1 | 0.1 | 0.1 | 0.1 | 0.1 | 0.1 | 0.1 |
| of all | Moisture | 1.3 | 1.3 | 1.3 | 1.3 | 1.3 | 1.3 | 1.3 | 1.3 | 1.3 |
| polyols) | absorbent | | | | | | | | | |
| | Aluminum | 0.0 | 0.0 | 0.0 | 0.0 | 0.0 | 0.0 | 0.0 | 0.0 | 0.0 |
| | hydroxide | | | | | | | | | |
| | Ammonium | 26.6 | 26.6 | 26.6 | 26.6 | 26.6 | 26.6 | 26.6 | 26.6 | 26.6 |
| | polyphosphate | | | | | | | | | |
| | Expanded | 26.6 | 26.6 | 26.6 | 26.6 | 26.6 | 26.6 | 26.6 | 26.6 | 26.6 |
| | graphite | | | | | | | | | |
| Total amount of pow- | | 53.2 | 53.2 | 53.2 | 53.2 | 53.2 | 53.2 | 53.2 | 53.2 | 53.2 |
| der flame retardants | | | | | | | | | | |
| Isocyanate INDEX | | 104 | 104 | 104 | 104 | 104 | 104 | 104 | 94 | 104 |
| Mixing ratio of foam- | | 40.0 | 29.5 | 73.9 | 29.5 | 76.0 | 29.5 | 80.0 | 80.0 | 73.9 |
| forming gas (volume %) | | | | | | | | | | |
| Thickness (mm) | | 1.0 | 1.0 | 1.8 | 1.8 | 3.0 | 3.0 | 5.5 | 5.5 | 8.8 |
| Density (kg/m³) | | 600 | 705 | 261 | 705 | 240 | 705 | 200 | 200 | 261 |
| Evaluation | Compression set | 5.6 | 6.0 | 3.5 | 6.2 | 3.8 | 5.3 | 2.6 | 6.5 | 2.5 |
| results | (50%, 100° C., | | | | | | | | | |
| | 22 hours) | | | | | | | | | |
| | UL-94 flame test | V-0 | V-0 | V-0 | V-0 | V-0 | V-0 | V-0 | V-0 | V-0 |
| | Viscosity | 5700 | 5700 | 5700 | 5700 | 5700 | 5700 | 5700 | 5700 | 5700 |
| | mPa · s (23° C.) | | | | | | | | | |

| | | Example | | | | | | | | |
|---|---|---|---|---|---|---|---|---|---|---|
| | | 10 | 11 | 12 | 13 | 14 | 15 | 16 | 17 | 18 |
| Blending | Polyol 1 | 36.5 | 36.5 | 36.5 | 36.5 | 36.5 | 36.5 | 36.5 | 36.5 | 36.5 |
| ratio | Polyol 2 | 7.9 | 7.9 | 7.9 | 7.9 | 7.9 | 7.9 | 7.9 | 7.9 | 7.9 |
| (Parts by | Polyol 3 | 9.0 | 9.0 | 9.0 | 9.0 | 9.0 | 9.0 | 9.0 | 9.0 | 9.0 |
| mass | Polyol 4 | 46.6 | 46.6 | 46.6 | 46.6 | 46.6 | 46.6 | 46.6 | 46.6 | 46.6 |
| relative | Foam stabilizer | 3.8 | 3.8 | 3.8 | 3.8 | 3.8 | 3.8 | 3.8 | 3.8 | 3.8 |
| to 100 | Catalyst 1 | 0.40 | 0.40 | 0.40 | 0.40 | 0.40 | 0.40 | 0.40 | 0.40 | 0.40 |
| parts by | Catalyst 2 | 0.02 | 0.02 | 0.02 | 0.02 | 0.02 | 0.02 | 0.02 | 0.02 | 0.02 |
| mass of | Pigment | 1.0 | 1.0 | 1.0 | 1.0 | 1.0 | 1.0 | 1.0 | 1.0 | 1.0 |
| the sum | Antioxidant | 0.1 | 0.1 | 0.1 | 0.1 | 0.1 | 0.1 | 0.1 | 0.1 | 0.1 |
| of all | Moisture | 1.3 | 1.3 | 1.3 | 1.3 | 1.3 | 1.3 | 1.3 | 1.3 | 1.3 |
| polyols) | absorbent | | | | | | | | | |
| | Aluminum | 0.0 | 0.0 | 0.0 | 0.0 | 0.0 | 0.0 | 0.0 | 0.0 | 0.0 |
| | hydroxide | | | | | | | | | |
| | Ammonium | 21.6 | 36.7 | 46.7 | 24.1 | 24.1 | 21.6 | 21.6 | 26.6 | 26.6 |
| | polyphosphate | | | | | | | | | |
| | Expanded | 21.6 | 36.7 | 46.7 | 24.1 | 24.1 | 21.6 | 21.6 | 26.6 | 26.6 |
| | graphite | | | | | | | | | |
| Total amount of pow- | | 43.2 | 73.3 | 93.4 | 48.2 | 48.2 | 43.2 | 43.2 | 53.2 | 53.2 |
| der flame retardants | | | | | | | | | | |
| Isocyanate INDEX | | 104 | 104 | 104 | 104 | 104 | 104 | 104 | 104 | 104 |
| Mixing ratio of foam- | | 75.0 | 70.0 | 70.0 | 62.0 | 70.0 | 70.0 | 73.0 | 74.8 | 74.8 |
| forming gas (volume %) | | | | | | | | | | |
| Thickness (mm) | | 5.2 | 2.0 | 2.0 | 2.0 | 2.0 | 2.0 | 3.8 | 0.5 | 0.8 |
| Density (kg/m³) | | 250 | 300 | 300 | 380 | 300 | 300 | 270 | 252 | 252 |
| Evaluation | Compression set | 2.3 | 4.0 | 3.9 | 4.6 | 4.7 | 2.3 | 2.4 | 5.6 | 2.5 |
| results | (50%, 100° C., | | | | | | | | | |
| | 22 hours) | | | | | | | | | |
| | UL-94 flame test | V-0 | V-0 | V-0 | V-1 | V-1 | V-1 | V-1 | HF-1 | HF-1 |
| | Viscosity | 5200 | 18100 | 45000 | 5500 | 5500 | 5200 | 5200 | 5700 | 5700 |
| | mPa · s (23° C.) | | | | | | | | | |

| | | Example | | | Comparative example | | | | | |
|---|---|---|---|---|---|---|---|---|---|---|
| | | 19 | 20 | 21 | 1 | 2 | 3 | 4 | 5 | 6 |
| Blending | Polyol 1 | 36.5 | 36.5 | 36.5 | 36.5 | 53.7 | 53.7 | 53.7 | 53.7 | 85.4 |
| ratio | Polyol 2 | 7.9 | 7.9 | 7.9 | 7.9 | 5.4 | 5.4 | 5.4 | 5.4 | 5.4 |
| (Parts by | Polyol 3 | 9.0 | 9.0 | 9.0 | 9.0 | 9.2 | 9.2 | 9.2 | 9.2 | 9.2 |
| mass | Polyol 4 | 46.6 | 46.6 | 46.6 | 46.6 | 31.7 | 31.7 | 31.7 | 31.7 | 0.0 |
| relative | Foam stabilizer | 3.8 | 3.8 | 3.8 | 3.8 | 3.9 | 3.9 | 3.9 | 3.9 | 3.9 |
| to 100 | Catalyst 1 | 0.40 | 0.40 | 0.40 | 0.40 | 0.00 | 0.00 | 0.00 | 0.00 | 0.00 |
| parts by | Catalyst 2 | 0.02 | 0.02 | 0.02 | 0.02 | 0.01 | 0.01 | 0.01 | 0.01 | 0.01 |
| mass of | Pigment | 1.0 | 1.0 | 1.0 | 1.0 | 1.0 | 1.0 | 1.0 | 1.0 | 1.0 |
| the sum | Antioxidant | 0.1 | 0.1 | 0.1 | 0.1 | 0.1 | 0.1 | 0.1 | 0.1 | 0.1 |
| of all | Moisture | 1.3 | 1.3 | 1.3 | 1.3 | 2.6 | 2.6 | 2.6 | 2.6 | 2.6 |
| polyols) | absorbent | | | | | | | | | |
| | Aluminum | 0.0 | 0.0 | 0.0 | 0.0 | 32.4 | 32.4 | 32.4 | 32.4 | 32.4 |
| | hydroxide | | | | | | | | | |
| | Ammonium | 26.6 | 26.6 | 26.6 | 0.0 | 0.0 | 0.0 | 0.0 | 0.0 | 0.0 |
| | polyphosphate | | | | | | | | | |
| | Expanded | 26.6 | 26.6 | 26.6 | 0.0 | 0.0 | 0.0 | 0.0 | 0.0 | 0.0 |
| | graphite | | | | | | | | | |
| Total amount of pow- | | 53.2 | 53.2 | 53.2 | 0.0 | 32.4 | 32.4 | 32.4 | 32.4 | 32.4 |
| der flame retardants | | | | | | | | | | |
| Isocyanate INDEX | | 104 | 104 | 84 | 104 | 104 | 104 | 104 | 104 | 104 |
| Mixing ratio of foam- | | 56.8 | 56.8 | 80.0 | 70.0 | 82.5 | 65.0 | 82.5 | 65.0 | 68.0 |
| forming gas (volume %) | | | | | | | | | | |
| Thickness (mm) | | 0.5 | 0.8 | 5.5 | 2.0 | 1.8 | 1.8 | 5.5 | 5.5 | 1.5 |
| Density (kg/m³) | | 432 | 432 | 200 | 300 | 175 | 350 | 175 | 350 | 320 |
| Evaluation | Compression set | 6.0 | 5.0 | 15.0 | 6.5 | 5.6 | 5.6 | 4.0 | 4.0 | 21.5 |
| results | (50%, 100° C., | | | | | | | | | |
| | 22 hours) | | | | | | | | | |
| | UL-94 flame test | HF-1 | HF-1 | V-0 | Failed | HBF | HBF | HBF | HBF | HBF |
| | Viscosity | 5700 | 5700 | 5700 | 2500 | 3600 | 3600 | 3600 | 3600 | 2000 |
| | mPa · s (23° C.) | | | | | | | | | |

### (5) Observation

As shown in Table 4, Examples 1 to 21, which contained an inorganic phosphoric acid compound and expanded graphite and had a density of 150 kg/m³ or more, were all evaluated as good. On the other hand, Comparative Example 1, which did not use a flame retardant, failed all of the flame tests. Also, Comparative Examples 2 to 6, which used aluminum hydroxide instead of an inorganic phosphoric acid compound and expanded graphite, passed the horizontal flame test: HBF method flame test, but failed the HF method and vertical flame test.

Comparing the examples, Examples 17 to 20, which have a thickness of less than 1 mm, passed the horizontal flame test: HF method, but failed the vertical flame test. On the other hand, the other Examples, which have a thickness of 1 mm or more, also passed the vertical flame test. From these results, it was found that a polyurethane foam with a thickness of less than 1 mm can provide sufficient flame retardant effect, but that a thickness of 1 mm or more further improves flame retardancy.

1. A polyurethane foam comprising an inorganic phosphoric acid compound,
expanded graphite and a castor oil-based polyol as raw materials, and having a density of 150 kg/m³ or more.

2. The polyurethane foam according to claim 1, having a density of 600 kg/m³ or more and a thickness of 1.0 mm or more and 10 mm or less.

3. A battery or electric device comprising the polyurethane foam according to claim 1 having a density of 600 kg/m³ or more.

4. A method for producing the polyurethane foam according to claim 1, comprising a step of mixing a polyol, an isocyanate, the inorganic phosphoric acid compound, the expanded graphite, and a gas.

5. The polyurethane foam according to claim 1, wherein
the raw materials include a polyol containing the castor oil-based polyol,
the expanded graphite is contained in an amount of 20 parts by mass or more relative to 100 parts by mass of the polyol, and
the density is 600 kg/m³ or more.

6. The polyurethane foam according to claim 1 containing a moisture adsorbent and having a thickness of 1.0 mm or more and 10 mm or less.

7. The polyurethane foam according to claim 1, wherein
the raw materials include a polyol containing the castor oil-based polyol, and a moisture adsorbent, and
the expanded graphite is contained in an amount of 20 parts by mass or more relative to 100 parts by mass of the polyol.

8. A battery or electric device comprising the polyurethane foam according to claim 1 containing a moisture adsorbent.

9. The method for producing the polyurethane foam according to claim 4, comprising a step of supplying raw materials onto a film.

10. The method for producing the polyurethane foam according to claim 1 containing a moisture adsorbent, comprising a step of mixing a polyol, an isocyanate, the inorganic phosphoric acid compound, the expanded graphite, the moisture adsorbent, and a gas.

11. The method for producing the polyurethane foam according to claim 10, comprising a step of supplying raw materials on a film.
